(19) United States
(12) Patent Application Publication
(10) Pub. No.: US 2015/0061523 A1
(43) Pub. Date: Mar. 5, 2015

(54) CAPACITOR STEP-DOWN LED DRIVER AND DRIVING METHOD USING THE SAME

(71) Applicant: Silergy Semiconductor Technology (Hangzhou) Ltd., Hangzhou (CN)

(72) Inventor: Wei Chen, Hangzhou (CN)

(21) Appl. No.: 14/475,680

(22) Filed: Sep. 3, 2014

(30) Foreign Application Priority Data
Sep. 3, 2013 (CN) 201310395919.0

(51) Int. Cl. H05B 33/08

(52) U.S. Cl. CPC H05B 33/0815
USPC 315/200 R; 315/227 R

(57) ABSTRACT

The present disclosure relates to a capacitor step-down LED driver and a driving method using the same. A capacitor step-down LED driver comprises a control circuit and a switching circuit. The control circuit turns on or off the switching circuit in response to an output current and an output voltage of the capacitor step-down LED driver, and thus controls an amount of energy supplied from an input side to an output side. In a first operation state, the switching circuit is controlled not to supply energy from the input side to the output side. In a second operation state, the switching circuit is controlled to supply energy from the input side to the output side. Thus, the output current is maintained to be a value of a desired driving current.

### RELATED APPLICATIONS

This application claims the benefit of Chinese Patent Application No. 201310395919.0, filed on Sep. 3, 2013, which is incorporated herein by reference in its entirety.

### TECHNICAL FIELD

The present disclosure generally relates to the field of electronics, and more specifically, to a capacitor step-down LED driver and a driving method using the same.

### BACKGROUND

LED lamps are now widely used and LED driving technology is also well known. There are many approaches for driving LEDs in the prior art, including, for example, PWM constant current driving approach and capacitor step-down LED driving circuit. The PWM constant current driving approach provides a good constant control on an output current. Thus, many constant current control chips are commercially available. However, this kind of driving approach is very expensive and very complex, and results in difficulties in circuit design. The capacitor step-down LED driving circuit is simple and cheap, and thus is widely used as a low-power LED lighting driving circuit.

A schematic diagram of a capacitor step-down LED driving circuit according to the prior art is shown in FIG. 1. According to the principle that a capacitive reactance limits a current, an AC power supply V_{ac} drops after passing an input capacitor Cᵢₙ, and is then supplied to an rectifier circuit 11. The rectifier circuit 11 outputs a DC voltage, which is filtered by an output capacitor Cₒᵤₜ and then supplied to a LED load as an output voltage. A resistor R₁ is coupled in parallel with an input capacitor Cᵢₙ, and provides a path for discharging the input capacitor Cᵢₙ when the AC power supply is turned off.

In the capacitor step-down LED driving circuit according to the prior art as shown in FIG. 1, an output current, which is also a LED driving current, varies greatly with the input capacitor Cᵢₙ and the AC power supply V_{ac}. Consequently, the LED has an unstable brightness. Moreover, the LED driving current depends on a value of the input capacitor Cᵢₙ. The LED driving current decreases when a capacitance value of the input capacitor Cᵢₙ decreases. Consequently, the LED has a decreased brightness. A design scheme of the capacitor step-down LED driving circuit according to the prior art cannot ensure stability of the LED load because the output voltage decreases significantly when the LED load increases. The output capacitor Cₒᵤₜ explodes when the AC power supply is excessively high. Moreover, the capacitor step-down LED driving circuit according to the prior art has many safety problems because it lacks surge current limitation, output short circuit protection and open circuit protection.

### SUMMARY

In view of this, one object of the present disclosure is to provide a novel capacitor step-down LED driver and a method using the same, to solve the problems of poor stability, short lifetime and low efficiency of the capacitor step-down LED driver according to the prior art.

According to one aspect of the present disclosure, there is provided a capacitor step-down LED driver for receiving an AC power supply at an input side and generating an output voltage and an output current at an output side to drive a LED load, comprising an input capacitor, a rectifier circuit, an output capacitor, a control circuit and a switching circuit,

wherein a first terminal of the input capacitor is coupled to a first terminal of the AC power supply, a second terminal of the input capacitor is coupled to a first input terminal of the rectifier circuit, and a second input terminal of the rectifier circuit is coupled to a second terminal of the AC power supply;

the output capacitor is coupled in parallel to the LED load;

the switching circuit is coupled between an output terminal of the rectifier circuit and the output capacitor;

the control circuit turns on or off the switching circuit in response to the output current, and thus controls an amount of energy supplied from the input side to the output side;

the switching circuit is controlled not to supply energy from the input side to the output side in a first operation state that the output current is larger than a desired driving current; and

the switching circuit is controlled to supply energy from the input side to the output side in a second operation state that the output current is less than the desired driving current to maintain the output current to be a value of the desired driving current.

Preferably, the switching circuit comprises a first switch coupled between two output terminals of the rectifier circuit, and the first switch is turned on in the first operation state and is turned off in the second operation state.

Preferably, the switching circuit further comprises a second switch coupled in series between the first switch and the output capacitor, and the second switch is turned on when a rectified output voltage of the rectifier circuit is larger than the output voltage in the second operation state.

Preferably, the second switch comprises a diode or a controllable switch.

Preferably, the control circuit comprises a zero-crossing signal generating circuit and an OFF signal generating circuit;

the zero-crossing signal generating circuit generates a zero-crossing signal in response to an input voltage of the rectifier circuit of the capacitor step-down LED driver, and the switching circuit prevents energy from being supplied from the input side to the output side in response to the zero-crossing signal when the input voltage crosses zero; and

the OFF signal generating circuit generates an OFF signal after a time period in accordance with an error between the current output current and the desired driving current, to allow energy to be supplied from the input side to the output side.

According to another aspect of the present disclosure, there is provided a driving method using a capacitor step-down LED driver to generate an output voltage and an output current for driving a LED load, comprising

comparing the output current and a desired driving current;

preventing energy from being supplied from an input side to an output side of the capacitor step-down LED driver when the output current is larger than the desired driving current; and

supplying energy from the input side to the output side to maintain the output current to be a value of the desired driving current when the output current is less than the desired driving current.

Preferably, the step of supplying energy from the input side to the output side further comprises:

comparing a rectified output voltage of the capacitor step-down LED driver and the output voltage;

preventing energy from being supplied from the input side to the output side when the rectified output voltage is less than the output voltage;

supplying energy from the input side to the output side to maintain the output current to be a value of the desired driving current when the rectified output voltage is larger than the output voltage.

Preferably, the step of preventing energy from being supplied from the input side to the output side further comprises:

detecting an input voltage of the rectifier circuit of the capacitor step-down LED driver;

preventing energy from being supplied from the input side to the output side from the moment the input voltage crosses zero; and

supplying energy from the input side to the output side after a time period indicative of an error between the current output current and the desired driving current has elapsed.

The capacitor step-down LED driver and the driving method using the same according to the embodiments of the present disclosure control energy supplied from the input side to the output side in accordance with the current state of the LED load. For example, the capacitor step-down LED driver is controlled not to supply energy from the input side to the output side when the driving current is larger than the desired driving current, and is controlled to supply energy from the input side to the output side when the driving current of the LED is less than a reference current. The above feedback control adjusts the LED driving current in real-time response to an output electrical signal at the output side, and accurately controls the output signal while the load requirement is fulfilled. This feedback control reduces power loss and improves operating efficiency. Meanwhile, variations of the AC power supply and the input capacitor will not change the LED driving current, resulting in increased stability and lifetime of the circuit. Furthermore, the reliability of the circuit is also improved by the short circuit protection and open circuit protection for the LED and the overvoltage protection for the input voltage (the AC power supply).

### BRIEF DESCRIPTION OF THE DRAWINGS

FIG. 1 illustrates a schematic block diagram of a capacitor step-down LED driving circuit according to the prior art;

FIG. 2 illustrates a schematic block diagram of a capacitor step-down LED driver according to a first embodiment of the present disclosure;

FIG. 3A illustrates a schematic block diagram of a capacitor step-down LED driver according to a second embodiment of the present disclosure;

FIG. 3B illustrates a waveform diagram showing example operation of the capacitor step-down LED driver of FIG. 3A;

FIG. 4A illustrates a schematic block diagram of a capacitor step-down LED driver according to a third embodiment of the present disclosure;

FIG. 4B illustrates a waveform diagram showing example operation of the capacitor step-down LED driver of FIG. 4A;

FIG. 5 illustrates a schematic block diagram of a capacitor step-down LED driver according to a fourth embodiment of the present disclosure; and

FIG. 6 illustrates a flow diagram of a driving method using a capacitor step-down LED driver according to an embodiment of the present disclosure.

### DESCRIPTION OF EMBODIMENTS

Reference will now be made in detail to particular embodiments of the disclosure, examples of which are illustrated in the accompanying drawings. While the disclosure will be described in conjunction with the preferred embodiments, it will be understood that they are not intended to limit the disclosure to these embodiments. On the contrary, the disclosure is intended to cover alternatives, modifications and equivalents that may be included within the spirit and scope of the disclosure as defined by the appended claims. Furthermore, in the following detailed description of the present disclosure, numerous specific details are set forth in order to provide a thorough understanding of the present disclosure. However, it will be readily apparent to one skilled in the art that the present disclosure may be practiced without these specific details.

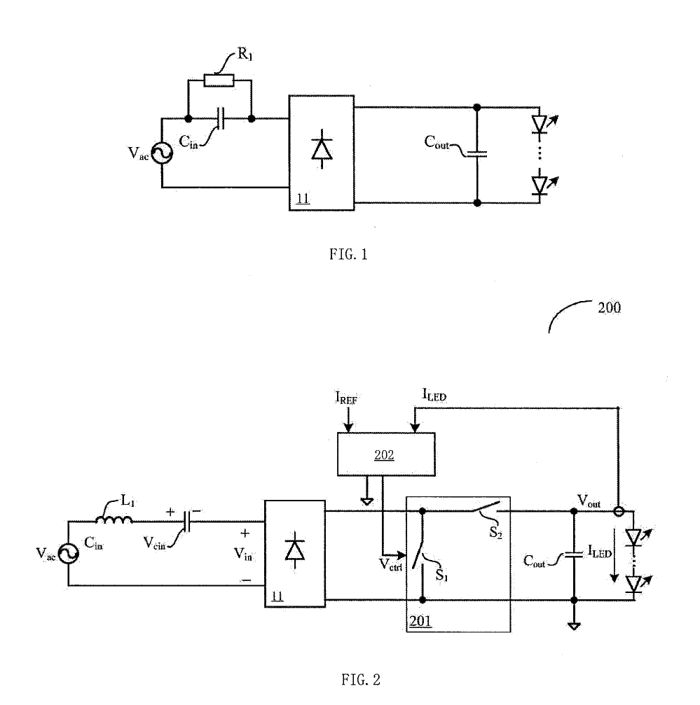

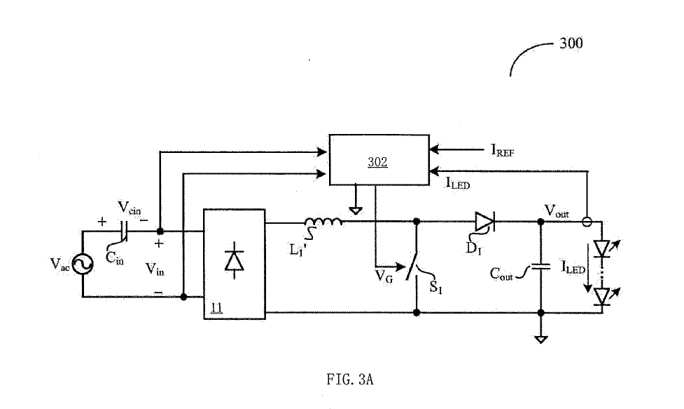

FIG. 2 illustrates a schematic block diagram of a capacitor step-down LED driver according to a first embodiment of the present disclosure. In this embodiment, the capacitor step-down LED driver 200 is used for driving a LED load. Compared with the conventional capacitor step-down LED driver shown in FIG. 1, the capacitor step-down LED driver 200 further comprises a switching circuit 201 and a control circuit 202 for controlling energy being supplied from an input side to an output side of the capacitor step-down LED driver 200.

A first terminal of the input capacitor Cᵢₙ is coupled to a first terminal of an AC power supply AC. A second terminal of the input capacitor Cᵢₙ is coupled an input terminal of a rectifier circuit 11. A second input terminal of the rectifier circuit 11 is coupled to a second terminal of the AC power supply AC. An output capacitor Cₒᵤₜ is coupled in parallel to the LED load. The switching circuit 201 is coupled between an output terminal of the rectifier circuit 11 and the output capacitor Cₒᵤₜ.

The control circuit 202 receives an output current I_{LED} and a desired driving current I_{REF} to generate a corresponding control signal V_{ctrl} for turning on or off the switching circuit 201.

The control circuit 202 controls the switching circuit 201 not to supply energy from an input side to an output side of the capacitor step-down LED driver 200 when the output current I_{LED} of the capacitor step-down LED driver 200 is larger than the desired driving current I_{REF}. Or otherwise, the control circuit 202 controls the switching circuit 201 to supply energy from the input side to the output side of the capacitor step-down LED driver 200 when the output current I_{LED} of the capacitor step-down LED driver 200 is less than the desired driving current I_{REF}. The feedback control accurately adjusts the output current I_{LED} to maintain the output current I_{LED} to be a value of the desired driving current I_{REF}. Meanwhile, this feedback control reduces power loss and improves operating efficiency. Meanwhile, variations of the AC power supply AC and the input capacitor Cᵢₙ will not change the LED driving current I_{LED}, resulting in increased stability and lifetime of the system.

Specifically, the switching circuit 201 comprises a first switch S1 coupled between two output terminals of the rectifier circuit 11.

The control circuit 202 generates a control signal V_{ctrl} for turning on the first switch S1 when the output current I_{LED} is larger than the desired driving current I_{REF}. In such case, the energy cannot be supplied from the input side to the output side. Instead, the energy circulates in a loop of the input AC power supply V_{ac}, the input capacitor Cin and the rectifier circuit 11 to decrease the output current I_{LED} of the capacitor step-down LED driver.

The control circuit 202 generates a control signal for turning off the first switch S1 when the output current I_{LED} is less than the desired driving current I_{REF}. That is, the energy is allowed to be supplied from the input side to the output side to increase the output current I_{ED} to be a value of the desired driving current I_{REF}.

The switching circuit 201 further comprises a second switch S2 coupled in series between a positive output terminal of the rectifier circuit 11 and a positive output terminal of the output capacitor Cₒᵤₜ.

The second switch S2 is turned on when a voltage at the positive output terminal of the rectifier circuit 11 is larger than the output voltage Vₒᵤₜ of the capacitor step-down LED driver. In such case, the energy is supplied from the input side to the output side when the output current I_{LED} is less than desired driving current I_{REF}. That is, the energy is supplied from the AC power supply V_{ac} at the input side to the output capacitor Cₒᵤₜ at the output side through the rectifier circuit 11 to increase the output current I_{LED} of the capacitor step-down LED driver.

Here, the second switch S2 may be any type of power switch, such as a diode, a controllable switch, and the like.

Moreover, a large surge current may occur in the operation of the system, especially at the moment when the switching circuit 201 is turned on. The large surge current, if it is not limited, may cause damages to the components in the system or even failure of the system. Thus, a certain surge current limiting circuit should be incorporated to avoid this. In this embodiment, a surge current limiting circuit is coupled in series between the AC power supply V_{ac} and the input capacitor Cᵢₙ to limit the surge current at the moment when the switching circuit 201 is turned on. The surge current limiting circuit may comprises an inductor L1. Alternatively, the surge current limiting circuit may be arranged elsewhere in the system, for example, at the interconnect between the output terminal of the rectifier circuit 11 and the switching circuit.

Here, the control circuit 202 and a main circuit of the capacitor step-down LED driver 200 may be at the same potential.

Compared with the prior art, the capacitor step-down LED driver according to the embodiment of the present disclosure has an controllable output electrical signal, such as an output current or an output voltage. It adjusts the output electrical signal by feedback control in response to the current output electrical signal. The output electrical signal is maintained to be constant, resulting in reduced power loss and increased operation efficiency. Meanwhile, variations of the AC power supply and the input capacitor will not change the LED driving current, resulting in increased stability and lifetime of the circuit.

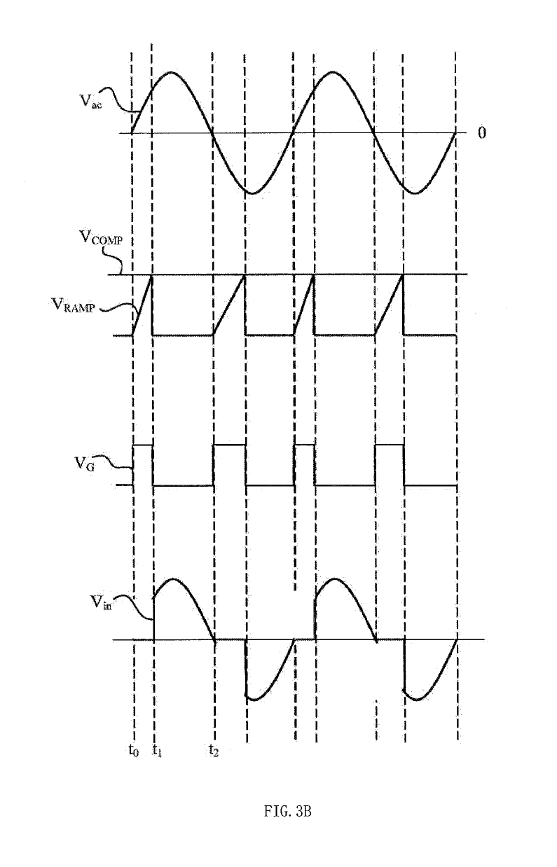

FIG. 3A illustrates a schematic block diagram of a capacitor step-down LED driver according to a second embodiment of the present disclosure.

In this embodiment, the second switch S2 in the capacitor step-down LED driver 300 is a unidirectional switch to ensure that the second switch S2 is turned on to allow the energy to be supplied from the input side to the output side only when the input voltage Vᵢₙ is larger than the output voltage Vₒᵤₜ. The second switch S2 is always turned off to prevent the energy from being inversely supplied from the output side to the input side when the input voltage Vᵢₙ is less than the output voltage Vₒᵤₜ. Here, the second switch S2 comprises a diode D1.

Moreover, frequently turning the first switch S1 on and off causes high conduction loss and high electromagnetic interference (EMI). The conduction loss may be greatly reduced by turning on the first switch S1 at a zero voltage. In this embodiment, the control circuit 302 detects the input voltage Vᵢₙ of the rectifier circuit 11 in real-time. The first switch S1 is turned on when the input voltage Vᵢₙ crosses zero, so that the first switch S1 is synchronized in phase to the input voltage Vᵢₙ to reduce the conduction loss and EMI of the first switch S1.

The first switch S1 is turned off in accordance with a time period indicative of an error between the current output current I_{LED} and the desired driving current I_{REF}. The time period is obtained from a ramp signal V_{RAMP} and a compensation signal V_{COMP} indicative of the error between the output current I_{LED} and the desired driving current I_{REF}.

FIG. 3B illustrates a waveform diagram showing example operation of the capacitor step-down LED driver 300 of FIG. 3A.

The input voltage Vᵢₙ of the rectifier circuit 11 is proportional to the AC power supply V_{ac}, with the same waveform, when the first switch S1 is turned off. Accordingly, the input voltage Vᵢₙ of the rectifier circuit 11 crosses zero when the AC power supply V_{ac} crosses zero at time t0.Meanwhile, the control circuit 302 generates a driving signal V_{G} with a high level to turn on the first switch S1. The ramp signal V_{RAMP} increases continuously from zero, while the input voltage Vᵢₙ maintains zero. At time t1, the ramp signal V_{RAMP} increases to a value of the compensation V_{COMP}, and the driving signal V_{G} changes to a low level to turn off the first switch S1. The input voltage Vᵢₙ follows the AC power supply V_{ac} again. The first switch S1 is turned on and off periodically in accordance with the error between the current LED driving current and the desired driving current to maintain the LED driving current I_{LED} to be constant.

In this embodiment, a surge limiting circuit with an inductor L1′ is also coupled in series between a positive output terminal of the rectifier circuit 11 and a first terminal of the first switch S1.

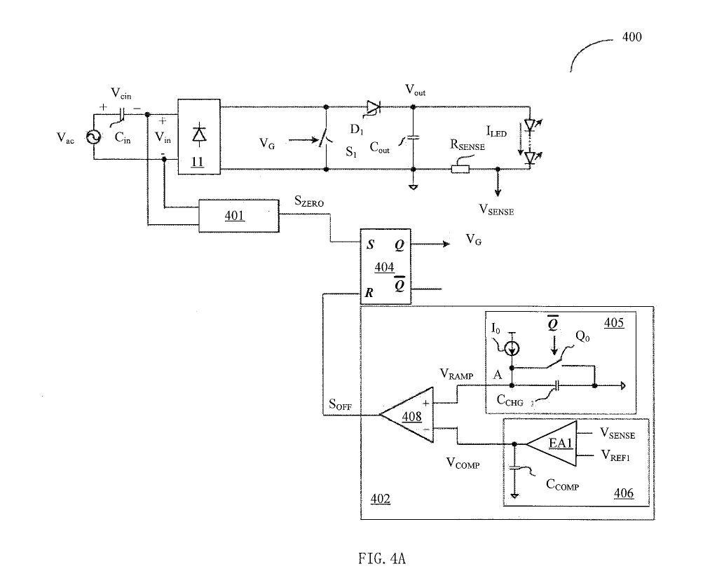

FIG. 4A illustrates a schematic block diagram of a capacitor step-down LED driver according to a third embodiment of the present disclosure. The schematic block diagram of the control circuit of the capacitor step-down LED driver and its operation principle will be explained in detail in this embodiment.

The control circuit comprises a zero-crossing signal generating circuit 401, an OFF signal generating circuit 402 and a logic circuit. The logic circuit comprises an RS flip-flop 404. An input terminal of the zero-crossing signal generating circuit 401 receives the input voltage Vᵢₙ, and generates a zero-crossing signal S_{ZERO} when the input voltage Vᵢₙ crosses zero. The zero-crossing signal S_{ZERO} sets the RS flip-flop 404 when the input voltage Vᵢₙ crosses zero, which in turn provides a control signal V_{G} at terminal Q to turn on the first switch S1 by a corresponding driving circuit so that the energy is prevented from being supplied from the input side to the output side.

The OFF signal generating circuit 402 is configured to provide a time period for turning off the first switch S1 to allow the energy to be supplied from the input side to the output side, when the time period has elapsed after the first switch S1 is turned on. The time period is indicative of an error between the current output current I_{LED} and the desired driving current I_{REF}.

In this embodiment, a detection resistor R_{SENSE} is coupled in series to the LED load to generate a detection voltage signal V_{SENSE} across the detection resistor R_{SENSE}, which is indicative of the output current I_{LED}. A reference voltage V_{REF1} is indicative of the desired driving current I_{REF}.

The OFF signal generating circuit 402 comprises a compensation signal generating circuit 406 and a ramp signal generating circuit 405.

The compensation signal generating circuit 406 generates a compensation signal V_{comp} indicative of an error between the current LED driving current and the desired driving current in accordance with the detection voltage signal V_{SENSE} and the reference voltage V_{REF1}. Specifically, the compensation signal generating circuit 406 comprises an error amplifier EA1 and a compensation capacitor C_{COMP} coupled to an output terminal of the error amplifier EA1. The error amplifier EA1 has two input terminals for receiving the detection voltage V_{SENSE} and the reference voltage V_{REF1} respectively, and has an output terminal for providing an output signal, which is then compensated by the compensation capacitor C_{COMP} to generate a compensation signal V_{COMP}.

The ramp signal generating circuit 405 is configured to generate a ramp signal V_{RAMP} which increases continuously after the first switch S1 is turned on. Specifically, the ramp signal generating circuit 405 comprises a current source I₀, a capacitor C_{CHG} coupled in series to the current source I₀, and a switch Q₀ coupled in parallel to the capacitor C_{CHG}. The switching state of the switch Q₀ is controlled by an inverse version of the control signal V_{G}. The current source l₀ charges the capacitor C_{CHG} when the first switch S1 is turned on, and the ramp signal V_{RAMP} at a common node A between the current source I₀ and the capacitor C_{CHG} increases continuously. A comparator 408 compares the received ramp signal V_{RAMP} with the received compensation signal V_{COMP}. When the ramp signal V_{RAMP} increases to a value of the compensation signal V_{COMP}, an output signal S_{OFF} of the comparator 408 resets the RS flip-flop 404 to turn off the first switch S1.

FIG. 4B illustrates a waveform diagram showing example operation of the capacitor step-down LED driver of FIG. 4A. The operation principle of the capacitor step-down LED driver 400 will be explained in detail with reference to its operation waveform.

In a state that the first switch S1 is turned off, for example, from time t0 to time t1, the input voltage Vᵢₙ is larger than the output voltage Vₒᵤₜ, and the diode D1 is in a forward conduction state. The input capacitor Cᵢₙ and the output capacitor Cₒᵤₜ are coupled in series across the AC power supply V_{ac}. Thus, the waveform of the input capacitor voltage V_{cin} is the same as that of the AC power supply V_{ac}, and the value of the input capacitor voltage V_{cin} is proportional to the value of the AC power supply V_{ac}. The value of the input voltage Vᵢₙ, increases continuously. At time t1, the input capacitor voltage V_{cin} and the AC power supply V_{ac} both reach a maximum value. From time t1 to t2, the AC power supply V_{ac} decreases, but the input capacitor voltage V_{cin} is maintained to be constant. At time t2, the AC power supply V_{ac} decreases to a value of the input capacitor voltage V_{cin}, and the input voltage Vᵢₙ decreases rapidly to zero. Meanwhile, the control signal V_{G} is changed to a high level and the first switch S1 is turned on. The ramp signal V_{RAMP} increases continuously from zero. At time t3, the ramp signal V_{RAMP} increases to a value of the compensation signal V_{COMP}, and the control signal V_{G} is changed to a low level and the first switch S1 is turned off. In a time period from t2 to t3, the first switch S1 is turned on, and the input capacitor voltage V_{cin} follows the AC power supply V_{ac}. Thus, the input voltage Vᵢₙ is maintained to be zero. In a time period from t3 to t4, the input voltage Vᵢₙ is less than the output voltage Vₒᵤₜ, and the diode D1 is in an off state. Thus, the input capacitor voltage V_{cin} is maintained to be constant. At time t4, the input voltage Vᵢₙ is larger than the output voltage Vₒᵤₜ, the diode D1 begins to conduct. The input capacitor voltage V_{cin} is again proportional to a value of the AC power supply V_{ac} until time t5. According to the same principle, the input voltage Vᵢₙ is changed to zero at time t6 during the negtive half cycle of the AC power supply V_{ac}, the first switch S1 is turned on again until time t7. The conduction time of the first switch S1 is repeatedly adjusted in accordance with an error between the current LED driving current and the desired driving current, so that the LED driving current is always maintained to be a value of the desired driving current.

The ramp signal generating circuit, the compensation signal generating circuit, and an example of the detection voltage signal indicative of the LED driving current are explained in detail in conjunction with the preferred embodiments. It is apparent for those skilled in the art that other implements can also be applied in the present disclosure.

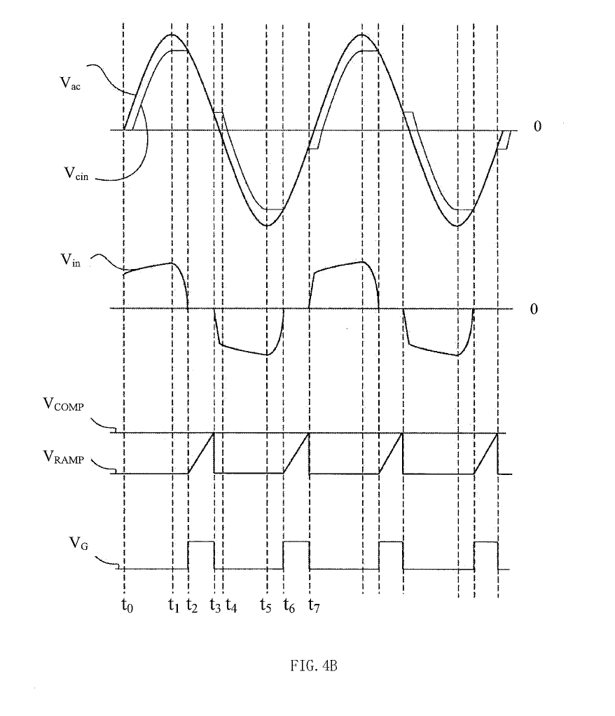

FIG. 5 illustrates a schematic block diagram of a capacitor step-down LED driver according to a fourth embodiment of the present disclosure. Compared with the embodiment shown in FIG. 4, the capacitor step-down LED driver 500 shown in FIG. 5 further comprises a LED short circuit protection circuit 503 and a LED open circuit protection circuit 505.

The LED short circuit protection circuit 503 receives the output voltage Vₒᵤₜ and a first threshold voltage Vₜₕ₁, and provides a short circuit protection signal S_{SHORT}. The LED open circuit protection circuit 505 receives the output voltage Vₒᵤₜ and a second threshold voltage Vₜₕ₂, and provides an open circuit protection signal S_{OPEN}.

A OR gate 504 has three input terminals for receiving the zero-crossing signal S_{ZERO} output from the zero-crossing signal generating circuit, a short circuit protection signal S_{SHORT} and an open circuit protection signal S_{OPEN}, respectively. The OR gate 504 provides an output signal to the RESET terminal S of the RS flip-flop 404 to turn on the first switch S when the input voltage Vᵢₙ crosses zero, or when the LED load is short circuited, or when the LED load is open circuited. When the output voltage Vₒᵤₜ is less than the first threshold voltage Vₜₕ₁, which indicates short circuit of the LED load, the first switch S1 is turned on to prevent the energy to be supplied from the input power supply to the output side. When the output voltage Vₒᵤₜ is larger than the second threshold voltage Vₜₕ₂, which indicates open circuit of the LED load, the first switch S1 is also turned on to prevent the energy to be supplied from the input power supply to the output side.

It is apparent that other implements of the short circuit protection of the LED load can also be applied in the present disclosure. For example, the control circuit is disabled in response to the short circuit protection signal S_{SHORT} when the LED load is short circuited.

On the other hand, the switching state of the first switch can also be controlled in response to the open circuit protection signal S_{OPEN} for the open circuit protection. For example, an AND gate 506 provides an output signal to the RESET terminal R of the RS flip-flop 404 to control the switching state of the first switch S1 when the ramp signal V_{RAMP} is larger than the compensation signal V_{COMP} and the LED load is not open circuited. The first switch S1 will not be turned off even in a case that the ramp signal V_{RAMP} is larger than the compensation signal V_{COMP}, when the output signal Vₒᵤₜ is larger than the second threshold voltage Vₜₕ₂, which indicates that the LED load is open circuited. It ensures that the energy is not supplied from the input side to the output capacitor Cₒᵤₜ, and prevents the output capacitor Cₒᵤₜ from exploding due to an excessively high voltage across the output capacitor Cₒᵤₜ.

An example of the zero-crossing signal generating circuit is also given in this embodiment. The zero-crossing signal generating circuit comprises a zero-crossing signal detection circuit 501 and a single pulse signal generating circuit 502. The zero-crossing detection circuit 501 provides an output signal to the single pulse signal generating circuit 502 to output a single pulse signal as a zero-crossing signal S_{ZERO}, when the input voltage Vᵢₙ crosses zero.

In an example, the LED short circuit protection circuit 503 comprises a first comparator having two input terminals for receiving the output voltage Vₒᵤₜ and a first threshold voltage indicative of short circuit of the LED load respectively. In a case that the output voltage is less than the first voltage threshold voltage, it is indicative of short circuit of the LED load.

Similarly, the LED open circuit protection circuit 505 comprises a second comparator having two input terminals for receiving the output voltage Vₒᵤₜ and a second threshold voltage indicative of open circuit of the LED load respectively. In a case that the output voltage is larger than the second voltage threshold voltage, it is indicative of open circuit of the LED load.

Here, a resistor divider network may also be used for sampling the output voltage. The above threshold voltages will be changed accordingly.

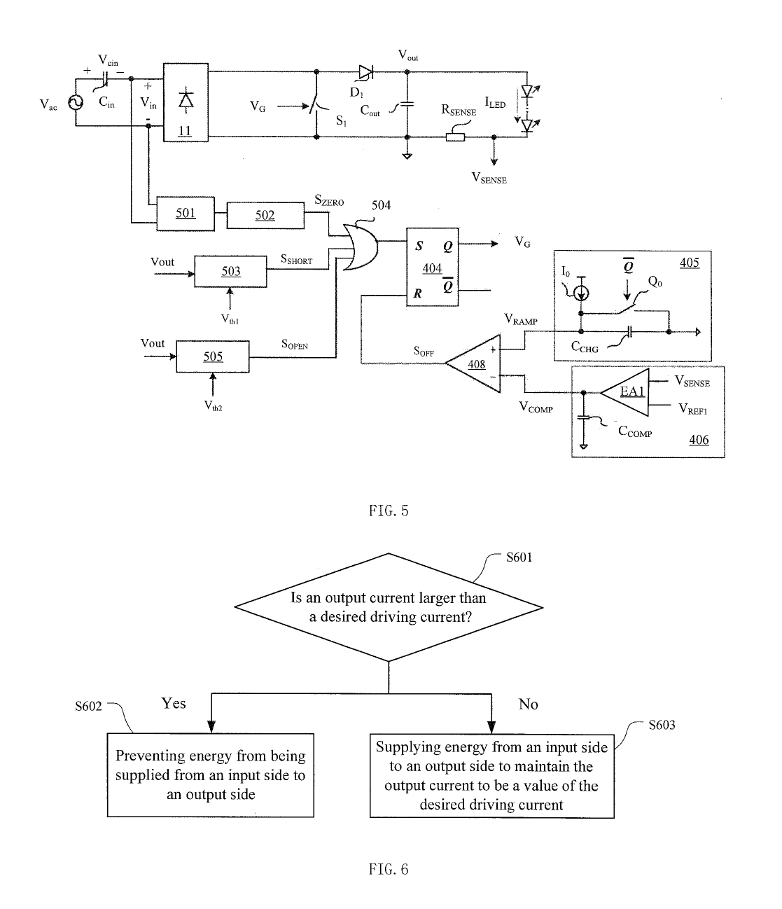

A driving method using a capacitor step-down LED driver according to an embodiment of the present disclosure will be explained in detail in conjunction with the preferred embodiments. FIG. 6 illustrates a flow diagram of a driving method using a capacitor step-down LED driver according to an embodiment of the present disclosure.

In this embodiment, the driving method using the capacitor step-down LED driver to generate an output voltage and an output current for driving a LED load, comprising:

S601: comparing the output current and a desired driving current;

S602: preventing energy from being supplied from an input side to an output side of the capacitor step-down LED driver when the output current is larger than the desired driving current; and

S603: supplying energy from the input side to the output side to maintain the output current to be a value of the desired driving current when the output current is less than the desired driving current.

Preferably, the step S603 of supplying energy from the input side to the output side further comprises:

comparing a rectified output voltage of the capacitor step-down LED driver and the output voltage;

preventing energy from being supplied from the input side to the output side when the rectified output voltage is less than the output voltage;

supplying energy from the input side to the output side to maintain the output current to be a value of the desired driving current when the rectified output current is larger than the desired output voltage.

Preferably, the step S602 of preventing energy from being supplied from the input side to the output side further comprises:

detecting an input voltage of the rectifier circuit of the capacitor step-down LED driver;

preventing energy from being supplied from the input side to the output side from the moment the input voltage crosses zero; and

supplying energy from the input side to the output side after a time period indicative of an error between the current output current and the desired driving current has elapsed.

According to an embodiment of the present disclosure, the step of generating the time period may comprise:

generating a compensation signal in accordance with an error between the current output current and the desired driving current;

In each switching cycle, the time period is from the moment the energy is prevented from being supplied from the input side to the output side and the ramp signal increases continuously from zero, to the moment the ramp signal reaches a value of the compensation signal.

In this embodiment, the driving method using the capacitor step-down LED driver further comprising limiting a surge current at the input side by using a magnetic component, which otherwise occurs when the switch is turned on and causes damages to the components in the circuit.

In this embodiment, the driving method using the capacitor step-down LED driver further comprising preventing energy from being supplied from the input side to the output side when the LED load is short circuited.

Here, determination of the short circuit of the LED load comprises:

comparing the output voltage with a first threshold voltage;

the LED load is short circuited in a case that the output voltage is less than the first threshold voltage.

In a case that the LED load is short circuited, one protection measure includes disabling the control circuit of the capacitor step-down LED driver.

In this embodiment, the driving method using the capacitor step-down LED driver further comprising preventing energy from being supplied from the input side to the output side when the LED load is open circuited.

Here, determination of the open circuit of the LED load comprises:

comparing the output voltage with a second threshold voltage;

the LED load is open circuited in a case that the output voltage is larger than the second threshold voltage.

In a case that the LED load is open circuited, the energy is prevented from being supplied from the input side to the output side. The output capacitor at the output side is well protected from exploding due to an excessively high voltage across the output capacitor.

In this embodiment, the driving method using the capacitor step-down LED driver further comprising limiting a surge current by using a magnetic component, which otherwise occurs at the input side when the switch change its switching state.

It should be understood that components in various embodiments may have the same function if they have the same name. A modified embodiment may incorporate elements in several relevant embodiments, though it may be described in connection with one of the previous embodiments. It is apparent for those skilled in the art, after reading the preferred embodiments of the present disclosure and without introducing no creative work, that any suitable circuit structure can be applied to the present disclosure, for example, other zero-crossing signal generating circuits, other LED short circuit protection circuits, other LED open circuit protection circuits, other ramp signal generating circuit and other compensation signal generating circuits, and the like. Thus, modifications that may be made by those skilled in the art, after reading the preferred embodiments, may be included within the spirit and scope of the invention.

It should also be understood that the relational terms such as “first”, “second”, and the like are used in the context merely for distinguishing one element or operation form the other element or operation, instead of meaning or implying any real relationship or order of these elements or operations. Moreover, the terms “comprise”, “comprising” and the like are used to refer to comprise in nonexclusive sense, so that any process, approach, article or apparatus relevant to an element, if follows the terms, means that not only said element listed here, but also those elements not listed explicitly, or those elements inherently included by the process, approach, article or apparatus relevant to said element. If there is no explicit limitation, the wording “comprise a/an . . . ” does not exclude the fact that other elements can also be included together with the process, approach, article or apparatus relevant to the element.

Although various embodiments of the present invention are described above, these embodiments neither present all details, nor imply that the present invention is limited to these embodiments. Obviously, many modifications and changes may be made in light of the teaching of the above embodiments. These embodiments are presented and some details are described herein only for explaining the principle of the invention and its actual use, so that one skilled person can practice the present invention and introduce some modifications in light of the invention. The invention is intended to cover alternatives, modifications and equivalents that may be included within the spirit and scope of the invention as defined by the appended claims.

What is claimed is:

1. A capacitor step-down LED driver for receiving an AC power supply at an input side and generating an output voltage and an output current at an output side to drive a LED load, comprising an input capacitor, a rectifier circuit, an output capacitor, a control circuit and a switching circuit,
wherein a first terminal of said input capacitor is coupled to a first terminal of said AC power supply, a second terminal of said input capacitor is coupled to a first input terminal of said rectifier circuit, and a second input terminal of said rectifier circuit is coupled to a second terminal of said AC power supply;
said output capacitor is coupled in parallel to said LED load;
said switching circuit is coupled between an output terminal of said rectifier circuit and said output capacitor;
said control circuit turns on or off said switching circuit in response to said output current, and thus controls an amount of energy supplied from said input side to said output side;
said switching circuit is controlled not to supply energy from said input side to said output side in a first operation state that said output current is larger than a desired driving current; and
said switching circuit is controlled to supply energy from said input side to said output side in a second operation state that said output current is less than said desired driving current to maintain said output current to be a value of said desired driving current.

2. The capacitor step-down LED driver according to claim 1, wherein said switching circuit comprises a first switch coupled between two output terminals of said rectifier circuit, and said first switch is turned on in said first operation state and is turned off in said second operation state.

3. The capacitor step-down LED driver according to claim 2, wherein said switching circuit further comprises a second switch coupled in series between said first switch and said output capacitor, and said second switch is turned on when a rectified output voltage of said rectifier circuit is larger than said output voltage in said second operation state.

4. The capacitor step-down LED driver according to claim 3, wherein said second switch comprises a diode or a controllable switch.

5. The capacitor step-down LED driver according to claim 1, further comprising a surge current limiting circuit for limiting a surge current when said switching circuit is turned on.

6. The capacitor step-down LED driver according to claim 5, wherein said surge current limiting circuit comprises a magnetic component.

7. The capacitor step-down LED driver according to claim 5, wherein said surge current limiting circuit is coupled between said AC power supply and said input capacitor.

8. The capacitor step-down LED driver according to claim 5, wherein said surge current limiting circuit is coupled between said output terminal of said rectifier circuit and said switching current.

9. The capacitor step-down LED driver according to claim 1, wherein said control circuit comprises a zero-crossing signal generating circuit and an OFF signal generating circuit;
said zero-crossing signal generating circuit generates a zero-crossing signal in response to an input voltage of said rectifier circuit of said capacitor step-down LED driver, and said switching circuit prevents energy from being supplied from said input side to said output side in response to said zero-crossing signal when said input voltage crosses zero; and
said OFF signal generating circuit generates an OFF signal after a time period in accordance with an error between said current output current and said desired driving current, to allow energy to be supplied from said input side to said output side.

10. The capacitor step-down LED driver according to claim 2, further comprising a LED short circuit protection circuit, wherein said control circuit turns on said first switch to prevent energy from being supplied from said input side to said output side when said LED load is short circuited.

11. The capacitor step-down LED driver according to claim 10, said LED short circuit protection circuit receives said output voltage and a first threshold voltage, wherein said LED short circuit protection circuit generates a short circuit protection signal to turn on said first switch when said output voltage is less than said first threshold voltage in a case that said LED load is short circuited.

12. The capacitor step-down LED driver according to claim 2, further comprising a LED open circuit protection circuit, wherein said control circuit turns on said first switch to prevent energy from being supplied from said input side to said output side when said LED load is open circuited.

13. The capacitor step-down LED driver according to claim 12, said LED open circuit protection circuit receives said output voltage and a second threshold voltage, wherein said LED open circuit protection circuit generates an open circuit protection signal to turn on said first switch when said output voltage is larger than said second threshold voltage in a case that said LED load is open circuited.

14. A driving method using a capacitor step-down LED driver to generate an output voltage and an output current for driving a LED load, comprising
comparing an output current and a desired driving current;
preventing energy from being supplied from an input side to an output side of said capacitor step-down LED driver when said output current is larger than said desired driving current; and
supplying energy from said input side to said output side to maintain said output current to be a value of said desired driving current when said output current is less than said desired driving current.

15. The driving method according to claim 14, further comprising limiting a surge current at said input side by using a magnetic component.

16. The driving method according to claim 14, wherein said step of supplying energy from said input side to said output side further comprises:
comparing a rectified output voltage of said capacitor step-down LED driver and said rectified output voltage;
preventing energy from being supplied from said input side to said output side when said rectified output voltage is less than said output voltage;
supplying energy from said input side to said output side to maintain said output current to be a value of said desired driving current when said rectified output voltage is larger than said output voltage.

17. The driving method according to claim 14, wherein said step of preventing energy from being supplied from said input side to said output side further comprises:
detecting an input voltage of said rectifier circuit of said capacitor step-down LED driver;
preventing energy from being supplied from said input side to said output side from the moment said input voltage crosses zero; and
supplying energy from said input side to said output side after a time period indicative of an error between said current output current and said desired driving current has elapsed.

18. The driving method according to claim 14, further comprising preventing energy from being supplied from said input side to said output side when said LED load is short circuited.

19. The driving method according to claim 14, further comprising preventing energy from being supplied from said input side to said output side when said LED load is open circuited.
